(19) United States
(12) Patent Application Publication
(10) Pub. No.: US 2025/0102329 A1
(43) Pub. Date: Mar. 27, 2025

(54) MAGNETIC SENSOR SYSTEM, AND DISTANCE MEASURING METHOD FOR THE MAGNETIC SENSOR SYSTEM

(71) Applicant: Panasonic Intellectual Property Management Co., Ltd., Osaka (JP)

(72) Inventor: Hideyuki TANIGAWA, Osaka (JP)

(21) Appl. No.: 18/832,854

(22) PCT Filed: Jan. 26, 2023
(86) PCT No.: PCT/JP2023/002377

§ 371 Date: Jul. 24, 2024

(30) Foreign Application Priority Data
Jan. 28, 2022 (JP) 2022-012418

(51) Int. Cl. G01D 5/245; G01D 18/00

(52) U.S. Cl. CPC G01D 5/245; G01D 18/001

(57) ABSTRACT

A magnetic scale is disposed alongside of a magnetic sensor in a first direction and moves relative to the magnetic sensor in a second direction intersecting with the first direction. A moving distance transformer receives an output signal of the magnetic sensor and transforms the output signal into moving distance information. A controller receives the moving distance from the transformer and gives a movement instruction to either the magnetic sensor or the magnetic scale. The moving distance transformer includes a hysteresis corrector. The controller provides the hysteresis corrector with moving direction information about the magnetic sensor. The hysteresis corrector transforms the output signal into the moving distance information by making hysteresis correction to the output signal based on the moving direction information.

### TECHNICAL FIELD

The present disclosure generally relates to a magnetic sensor system and a distance measuring method for the magnetic sensor system, and more particularly relates to a magnetic sensor system including a magnetic sensor and a magnetic scale which are movable relative to each other and a distance measuring method for use in such a magnetic sensor system.

### BACKGROUND ART

Patent Literature 1 discloses a magnetic sensor for use to inspect a flat-panel display. Patent Literature 1 describes, as a phenomenon observed in a magnetic sensor, a phenomenon (specifically, magnetic hysteresis) that as an external magnetic field is applied to, and removed from, the magnetic sensor, the resistance detected by a resistance detector circuit varies depending on the presence or absence of the external magnetic field (see paragraphs [0063] and [0064] of Patent Literature 1).

### CITATION LIST

### Patent Literature

Patent Literature 1: JP 2004-333469 A

### SUMMARY OF INVENTION

A general magnetic encoder includes: a magnetic scale with a permanent magnet; and a magnetic sensor with magnetoresistance elements for detecting a magnetic field from the magnetic scale. The permanent magnet of the magnetic scale forms a track on which N poles and S poles are arranged alternately in a relative movement direction of the magnetic sensor. The magnetic sensor detects either a distance or an angle by reading a magnetization pattern of the magnetic scale.

In the magnetic encoder, for example, the value (e.g., a rate of change in magnetic resistance in response to a magnetic field applied) measured when the magnetic sensor is moving in an outward direction while making reciprocating movement is different, due to the hysteresis characteristic of the magnetoresistance element as shown in FIG. 5, from the value measured when the magnetic sensor is moving in a homeward direction during the reciprocating movement. In that case, if the total error between the outward movement and the homeward movement is c1 (the same statement will be applied to the rest of the description), the settings are supposed to be made such that the difference between the measured value and the true value becomes ±c1/2. Consequently, the true value may be obtained based on the measured value by making a correction of +c1/2 when the magnetic sensor is moving in the outward direction and by making a correction of −c1/2 when the magnetic sensor is moving in the homeward direction.

However, making the correction of ±c1/2 to a region immediately following a point where the magnetic sensor makes a turnaround (hereinafter referred to as a “post-turnaround region”) (i.e., a point at which the magnetic sensor changes its moving direction) while making the reciprocating movement may cause an increase in the error. For example, in FIG. 3, which is a graph showing how the measured value changes according to the position of the magnetic sensor, the error is not constant but changes in a transitional region A1 that is the post-turnaround region due to the hysteresis characteristic of the magnetic sensor. Thus, making the correction of −c1/2 to the transitional region A1 based on its operating direction would cause an error as observed in an error generation region shown in FIG. 6 after the correction has been made.

Therefore, allowing the magnetic sensor that has once approached a target position to make a transition to the turnaround operation over a short distance would make the positional information too unstable to locate the magnetic sensor accurately.

It is therefore an object of the present disclosure to provide a magnetic sensor system and a distance measuring method for use in the magnetic sensor system, both contributing to stabilizing the positional information in a region immediately following a point where the magnetic sensor makes the turnaround while making the reciprocating movement with respect to the magnetic scale.

A magnetic sensor system according to an aspect of the present disclosure includes a magnetic sensor, a magnetic scale, a transformer, and a controller. The magnetic scale is disposed alongside of the magnetic sensor in a first direction and moves relative to the magnetic sensor in a second direction intersecting with the first direction. The transformer receives an output signal of the magnetic sensor and transforms the output signal into moving distance information. The controller receives the moving distance information from the transformer and gives a movement instruction to either the magnetic sensor or the magnetic scale. The transformer includes a hysteresis corrector. The controller provides the hysteresis corrector with moving direction information about either the magnetic sensor or the magnetic scale. The hysteresis corrector transforms the output signal into the moving distance information by making hysteresis correction to the output signal based on the moving direction information.

A distance measuring method for a magnetic sensor system according to another aspect of the present disclosure is a distance measuring method for use in a magnetic sensor system. The magnetic sensor system includes: a magnetic sensor; and a magnetic scale disposed alongside of the magnetic sensor in a first direction and moving relative to the magnetic sensor in a second direction intersecting with the first direction. The distance measuring method includes a transformation step including transforming an output signal of the magnetic sensor into moving distance information about either the magnetic sensor or the magnetic scale. The transformation step includes a correction step including transforming the output signal into the moving distance information by making hysteresis correction to the output signal based on the moving direction information about either the magnetic sensor or the magnetic scale.

A magnetic sensor system and distance measuring method for the magnetic sensor system according to an aspect of the present disclosure contributes to stabilizing positional information in a region immediately following a point where the magnetic sensor makes a turnaround while making reciprocating movement with respect to a magnetic scale.

### BRIEF DESCRIPTION OF DRAWINGS

FIG. 1 illustrates a schematic configuration for a magnetic sensor system according to an exemplary embodiment;

FIG. 2 is a flowchart showing how a moving distance transformer included in the magnetic sensor system performs moving distance transformation and hysteresis correction control operations;

FIG. 3 is a graph showing how a measured value changes with the position of the magnetic sensor and specifically showing how to correct the measured value in a transitional region where the magnetic sensor that has been moving in an outward direction starts moving in a homeward direction;

FIG. 4 is a graph showing how a measured value changes with the position of the magnetic sensor and specifically showing how to correct the measured value in a transitional region where the magnetic sensor that has been moving in the homeward direction starts moving in the outward direction;

FIG. 5 is a graph showing, as magnetic hysteresis, how the magnetic resistance change rate changes with the magnetic field; and

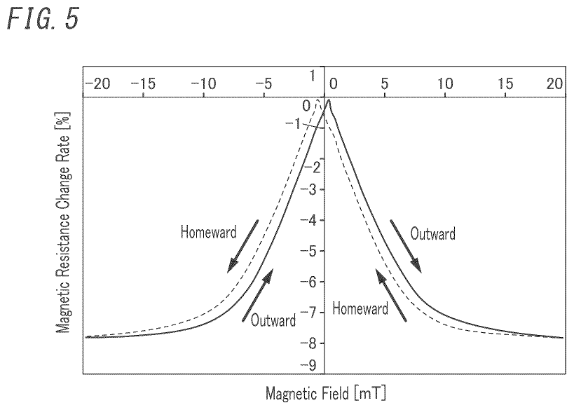

FIG. 6 is a graph showing how the measured value changes with the position of the magnetic sensor and specifically showing how the measured value may be corrected, for example, in the transitional region where the magnetic sensor that has been moving in the outward direction starts moving in the homeward direction.

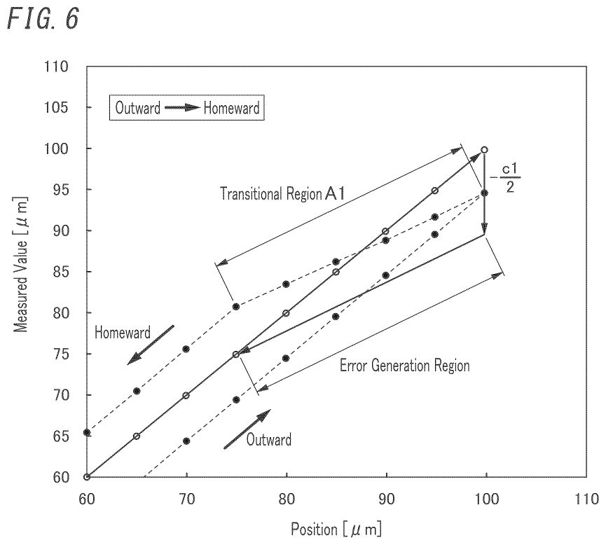

### DESCRIPTION OF EMBODIMENTS

### Embodiment

A magnetic sensor system according to an exemplary embodiment will now be described with reference to the accompanying drawings. The drawings to be referred to in the following description of embodiments are all schematic representations. Thus, the ratio of the dimensions (including thicknesses) of respective constituent elements illustrated on the drawings does not always reflect their actual dimensional ratio. Note that the exemplary embodiment to be described below is only an exemplary one of various embodiments of the present disclosure and should not be construed as limiting. Rather, the exemplary embodiment may be readily modified in various manners depending on a design choice or any other factor without departing from the scope of the present disclosure.

### (1) Magnetic Sensor System

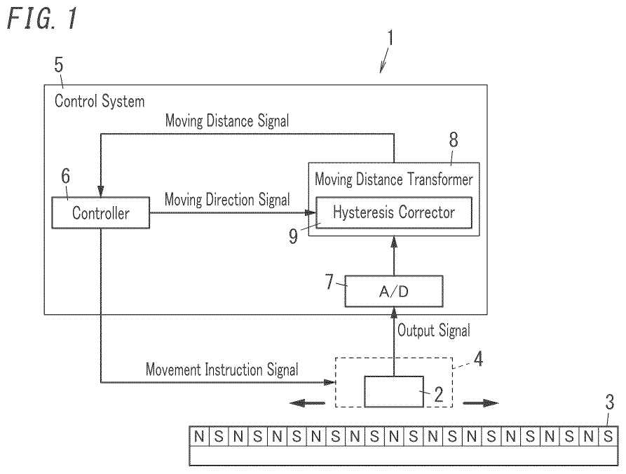

A magnetic sensor system 1 according to this embodiment will be described with reference to FIG. 1. The magnetic sensor system 1 is a system having the ability to measure, on a microscopic unit (e.g., on a μm scale) basis, movement information (such as position and moving distance) about a linear stage 4 (to be described later) serving as a mover. The magnetic sensor system 1 includes a magnetic sensor 2, a magnetic scale 3, the linear stage 4, and a control system 5.

The magnetic sensor 2 may be configured as, for example, a substantially rectangular parallelepiped package in which magnetoresistance elements and other components are molded with resin.

The magnetic scale 3 is extended straight in one direction. The magnetic scale 3 has a track on which N poles and S poles are alternately arranged along a longitudinal axis thereof.

The magnetic sensor 2 is disposed in the vicinity of the magnetic scale 3. Specifically, the magnetic sensor 2 is spaced from the magnetic scale 3 in the upward/downward direction (which is an exemplary first direction) in FIG. 1. The magnetic sensor 2 may be moved by the linear stage 4 along the longitudinal axis of the magnetic scale 3 (which is an exemplary second direction intersecting with the first direction). The magnetic sensor 2 detects its own position while moving along the longitudinal axis of the magnetic scale 3 by detecting the direction of change in the magnetic field generated on the surface of the magnetic scale 3.

Note that in the following description, the movement of the linear stage 4 and the magnetic sensor 2 to the right in FIG. 1 relative to the magnetic scale 3 will be hereinafter referred to as “movement in a first moving direction” and their relative movement to the left in FIG. 1 will be hereinafter referred to as “movement in a second moving direction.”

### (2) Control System

The control system 5 is a system for detecting the position and moving distance of the magnetic sensor 2 and controlling the movement of the magnetic sensor 2.

The control system 5 includes a computer system. The computer system includes a processor and a memory as principal hardware components thereof. The computer system performs the functions of the control system 5 according to this embodiment or serves as the agent that performs the distance measuring method according to this embodiment by making the processor execute a program stored in the memory of the computer system. The program may be stored in advance in the memory of the computer system. Alternatively, the program may also be downloaded through a telecommunications line or be distributed after having been recorded in some non-transitory storage medium such as a memory card, an optical disc, or a hard disk drive, any of which is readable for the computer system. The processor of the computer system may be made up of a single or a plurality of electronic circuits including a semiconductor integrated circuit (IC) or a large-scale integrated circuit (LSI). Those electronic circuits may be either integrated together on a single chip or distributed on multiple chips, whichever is appropriate. Those multiple chips may be aggregated together in a single device or distributed in multiple devices without limitation.

The control system 5 includes a controller 6, an A/D converter 7, and a moving distance transformer 8 (hereinafter simply referred to as a “transformer 8”).

The controller 6 controls the movement of the linear stage 4 based on the moving distance of the magnetic sensor 2 and the linear stage 4. Specifically, the controller 6 is provided with moving distance information by the transformer 8. In accordance with the moving distance information, the controller 6 transmits a movement instruction signal to the linear stage 4 to cause the linear stage 4 to move to a target position.

As the linear stage 4 moves, the magnetic sensor 2 generates, as output signals, a sinusoidal wave signal and a cosine wave signal.

The A/D converter 7 subjects the output signal of the magnetic sensor 2 to analog-to-digital conversion and outputs the signal thus generated to the transformer 8.

The transformer 8 receives the output signal of the magnetic sensor 2 and transforms the output signal into a moving distance signal. Specifically, the transformer 8 includes a hysteresis corrector 9 (hereinafter simply referred to as a “corrector 9”). The controller 6 provides the corrector 9 with moving direction information about the magnetic sensor 2 and the linear stage 4 (i.e., information indicating which direction the magnetic sensor 2 and the linear stage 4 are moving in). The corrector 9 transforms the output signal into the moving distance signal by making a hysteresis correction to the output signal in accordance with the moving direction information.

### (3) Distance Measuring Method

### (3.1) Overview of Distance Measuring Method

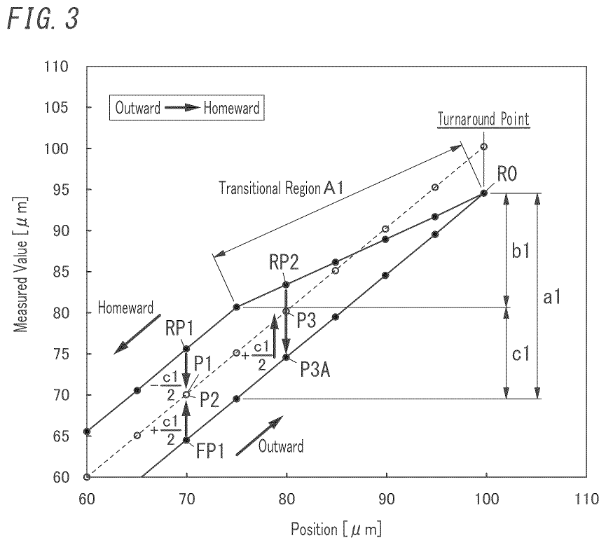

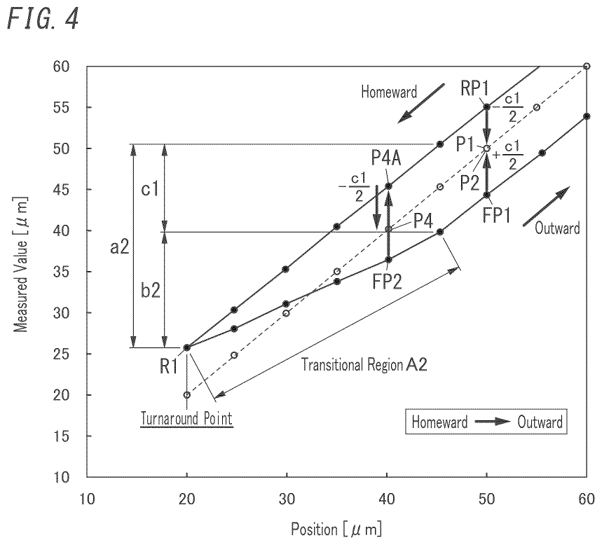

In FIGS. 3 and 4, the measured value provided for the corrector 9 means an output signal. The output signal includes: a first output signal as an output signal for a steady-state region; and a second output signal as an output signal for a transitional region immediately following a point where the magnetic sensor 2 changes its moving direction. Thus, in FIG. 3, shown is a transitional region A1 where the magnetic sensor 2 changes its moving direction from the outward direction (i.e., movement of the magnetic sensor 2 in the first moving direction) to the homeward direction (i.e., movement of the magnetic sensor 2 in the second moving direction). In FIG. 4, shown is a transitional region A2 where the magnetic sensor 2 changes its moving direction from the homeward direction to the outward direction.

The hysteresis corrector 9 makes the hysteresis correction differently to the steady-state region (i.e., a region, other than the transitional region A1, A2, where the error is constant) and the transitional region A1, A2 in accordance with the moving direction information. Making a hysteresis correction to the transitional region A1, A2 differently from the steady-state region in this manner enables optimizing correction to the error between the outward and homeward movements in the transitional region A1, A2. Consequently, this allows the positional information to be stabilized in the region immediately following a point where the magnetic sensor 2 makes a turnaround while making the reciprocating movement relative to the magnetic scale 3.

More specifically, the hysteresis corrector 9 transforms the second output signal to allow the second output signal to have an error of the same magnitude as in the steady-state region and makes an error correction, applied to the steady-state region, to the second output signal that has been transformed. As can be seen, the hysteresis correction made to the transitional region A1, A2 includes the error correction applied to the steady-state region, thus allowing the correction calculation to be simplified.

### (3.2) Details of Distance Measuring Method

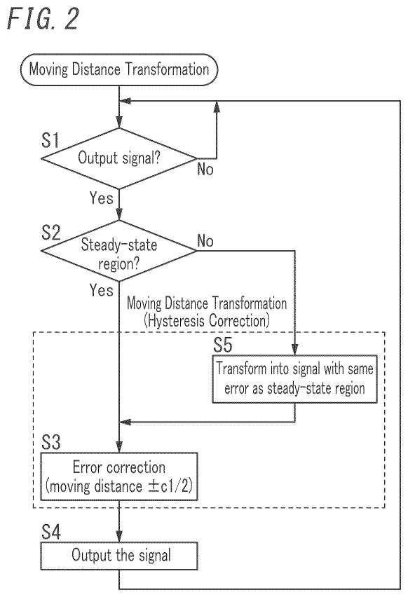

Next, a distance measuring method using the magnetic sensor system 1 (specifically, a moving distance transformation step (hereinafter simply referred to as a “transformation step”)) will be described in detail with reference to FIGS. 2-4. The transformation step includes transforming the output signal of the magnetic sensor 2 into a moving distance signal. The transformation step includes a correction step (Steps S3, S5) including transforming the output signal into the moving distance signal by making hysteresis correction to the output signal based on the moving direction information.

FIG. 2 shows how the corrector 9 of the transformer 8 performs the moving distance transformation and hysteresis correction control.

Note that the control flowchart to be described below is only an example. Thus, the processing steps shown in FIG. 2 may be performed in a different order from the one shown in FIG. 2, some of the processing steps shown in FIG. 2 may be omitted as appropriate, two or more of the processing steps shown in FIG. 2 may be performed in parallel, and/or some or all of these processing steps may be performed in an overlapping manner.

Furthermore, each block of the control flowchart does not necessarily represent a single control operation but may also be replaced with a plurality of control operations represented by a plurality of blocks.

In Step S1, the corrector 9 waits for an output signal to arrive.

On receiving the output signal, the corrector 9 determines, based on a moving direction signal supplied from the controller 6, whether the given region is a steady-state region (in S2).

If the given region is a steady-state region, the corrector 9 makes an error correction to the first output signal (in S3). As shown in FIGS. 3 and 4, the corrector 9 calculates a correction value Pl applied to a situation where the magnetic sensor 2 moves in the outward direction in the steady-state region by P1=FP1+c1/2, where FP1 is a measured value and c1 is a total error in a situation where the magnetic sensor 2 moves in the outward direction in the steady-state region and in a situation where the magnetic sensor 2 moves in the homeward direction. Furthermore, as shown in FIGS. 3 and 4, the corrector 9 also calculates a correction value P2 applied to a situation where the magnetic sensor moves in the homeward direction in the steady-state region by P2=RP1−c1/2, where RP1 is a measured value.

The corrector 9 outputs the moving distance signal thus subjected to the error correction to the controller 6 (in S4).

After Step S4 has been performed, the process returns to Step S1.

If the given region is not the steady-state region, the corrector 9 determines the given region to be the transitional region A1, A2 and transforms the second output signal so that the second output signal has the same error as in the steady-state region (in S5).

Next, it will be described how to make moving distance transformation about the transitional region A1. The corrector 9 calculates, in Step S5, a transformed value P3A by P3A=R0−(R0−RP2)×a1/b1, where P3 is a correction value applied to the transitional region A1 immediately following a point where the magnetic sensor changes the moving direction from the outward direction into the homeward direction, P3A is a transformed value, and RP2 is a measured value. Note that R0 is a measured value at a turnaround point where the magnetic sensor changes the moving direction from the outward direction before the correction into the homeward direction, a1 is a measured value width of the steady-state region with respect to the entire transitional region A1, and b1 is a measured value width of the entire transitional region A1. This means that the measured value RP2 for the transitional region A1 has been transformed into the measured value FP1 for the steady-state region. Subsequently, Step S3 includes calculating the correction value P3 by P3=P3A+c1/2.

Next, it will be described how to make moving distance transformation about the transitional region A2. The corrector 9 calculates, in Step S5, a transformed value P4A by P4A=R1+(FP2−R1)×a2/b2, where P4 is a correction value applied to the transitional region A2 immediately following a point where the magnetic sensor 2 changes the moving direction from the homeward direction into the outward direction, P4A is a transformed value, and FP2 is a measured value. Note that R1 is a measured value at a turnaround point where the magnetic sensor 2 changes the moving direction from the outward direction into the homeward direction, a2 is a measured value width of the steady-state region with respect to the entire transitional region A2, and b2 is a measured value width of the entire transitional region A2. This means that the measured value FP2 for the transitional region A2 has been transformed into the measured value RP1 for the steady-state region. Subsequently, Step S3 includes calculating the correction value P4 by P4=P4A−c1/2.

### (4) Variations

Note that the embodiment described above is only an exemplary one of various embodiments of the present disclosure and should not be construed as limiting. Rather, the exemplary embodiment may be readily modified in various manners depending on a design choice or any other factor without departing from the scope of the present disclosure. Next, variations of the exemplary embodiment will be enumerated one after another. Note that the variations to be described below may be adopted in combination as appropriate.

The magnetic scale 3 is allowed to move with the magnetic sensor 2 kept standing still.

The magnetic scale 3 may have two or more tracks.

Two or more magnetic sensors 2 may be provided.

The values of the output signals for the steady-state region and the transitional region are not limited to the values cited in the foregoing description of embodiments. Thus, the error correction and the hysteresis correction do not have to be made just as described in the foregoing description of embodiments.

### Aspects

The present disclosure has the following aspects.

A magnetic sensor system (1) according to a first aspect includes a magnetic sensor (2), a magnetic scale (3), a transformer (8), and a controller (6).

The magnetic scale (3) is disposed alongside of the magnetic sensor (2) in a first direction and moves relative to the magnetic sensor (2) in a second direction intersecting with the first direction.

The transformer (8) receives an output signal of the magnetic sensor (2) and transforms the output signal into moving distance information.

The controller (6) receives the moving distance information from the transformer (8) and gives a movement instruction to either the magnetic sensor (2) or the magnetic scale (3).

The transformer (8) includes a hysteresis corrector (9).

The controller (6) provides the hysteresis corrector (9) with moving direction information about either the magnetic sensor (2) or the magnetic scale (3).

The hysteresis corrector (9) transforms the output signal into the moving distance information by making hysteresis correction to the output signal based on the moving direction information.

This aspect allows the positional information to be stabilized, by making hysteresis correction based on the moving direction information, in a region immediately following a point where the magnetic sensor (2) makes a turnaround while making reciprocating movement relative to the magnetic scale (3).

In a magnetic sensor system (1) according to a second aspect, which may be implemented in conjunction with the first aspect, the output signal includes: a first output signal as an output signal for a steady-state region; and a second output signal as an output signal for a transitional region (A1, A2) immediately following a point where either the magnetic sensor (2) or the magnetic scale (3) changes its moving direction. The hysteresis corrector (9) makes the hysteresis correction differently to the steady-state region and the transitional region (A1, A2) in accordance with the moving direction information.

This aspect enables optimizing correction to the error between the outward and homeward movements in the transitional region (A1, A2) by making a hysteresis correction to the transitional region (A1, A2) differently from the steady-state region. Consequently, this allows the positional information to be stabilized in the region immediately following a point where the magnetic sensor (2) makes a turnaround while making the reciprocating movement relative to the magnetic scale (3).

In a magnetic sensor system (1) according to a third aspect, which may be implemented in conjunction with the second aspect, the hysteresis corrector (9) transforms the second output signal to allow the second output signal to have an error of the same magnitude as in the steady-state region and makes an error correction, applied to the steady-state region, to the second output signal that has been transformed.

According to this aspect, the error correction applied to the steady-state region is made as a hysteresis correction to the transitional region, thus allowing the correction calculation to be simplified.

In a magnetic sensor system (1) according to a fourth aspect, which may be implemented in conjunction with the third aspect, the hysteresis corrector (9) performs the following operations.

The hysteresis corrector (9) calculates a correction value P1 applied to a situation where the magnetic sensor (2) moves in a first moving direction in the steady-state region by P1=FP1+c1/2, where FP1 is a measured value and c1 is a total error in a situation where the magnetic sensor (2) moves in the first moving direction in the steady-state region and in a situation where the magnetic sensor (2) moves in a second moving direction opposite from the first moving direction.

The hysteresis corrector (9) calculates a correction value P2 applied to a situation where the magnetic sensor (2) moves in the second moving direction in the steady-state region by P2=RP1−c1/2, where RP1 is a measured value.

The hysteresis corrector (9) calculates a correction value P3 applied to the transitional region (A1) immediately following a point where the magnetic sensor (2) changes the moving direction from the first moving direction into the second moving direction by P3=R0−(R0−RP2)×a1/b1+c1/2, where RP2 is a measured value, R0 is a turnaround measured value when the magnetic sensor (2) changes the moving direction from the first moving direction into the second moving direction, a1 is a measured value width of the steady-state region with respect to the transitional region (A1) in its entirety, and b1 is a measured value width of the transitional region (A1) in its entirety.

The hysteresis corrector (9) calculates a correction value P4 applied to the transitional region (A2) immediately following a point where the magnetic sensor (2) changes the moving direction from the second moving direction into the first moving direction by P4=R1+(FP2−R1)×a2/b2−c1/2, where FP2 is a measured value, R1 is a turnaround measured value when the magnetic sensor (2) changes the moving direction from the second moving direction into the first moving direction, a2 is a measured value width of the steady-state region with respect to the transitional region (A2) in its entirety, and b2 is a measured value width of the transitional region (A2) in its entirety.

According to this aspect, the error correction applied to the steady-state region is made as a hysteresis correction to the transitional region, thus reducing the computational complexity.

A distance measuring method for a magnetic sensor system (1) according to a fifth aspect is a distance measuring method for use in a magnetic sensor system (1) including: a magnetic sensor (2); and a magnetic scale (3) disposed alongside of the magnetic sensor (2) in a first direction and moving relative to the magnetic sensor (2) in a second direction intersecting with the first direction. The distance measuring method includes a transformation step (S3, S5) including transforming an output signal of the magnetic sensor (2) into moving distance information about either the magnetic sensor (2) or the magnetic scale (3). The transformation step (S3, S5) includes a correction step (S3, S5) including transforming the output signal into the moving distance information by making hysteresis correction to the output signal based on the moving direction information about either the magnetic sensor (2) or the magnetic scale (3).

This aspect allows the positional information to be stabilized, by making hysteresis correction based on the moving direction information, in a region immediately following a point where the magnetic sensor (2) makes a turnaround while making reciprocating movement relative to the magnetic scale (3).

In a distance measuring method for use in a magnetic sensor system (1) according to a sixth aspect, which may be implemented in conjunction with the fifth aspect, the output signal includes: a first output signal as an output signal for a steady-state region; and a second output signal as an output signal for a transitional region (A1, A2) immediately following a point where either the magnetic sensor (2) or the magnetic scale (3) changes its moving direction. The correction step (S3, S5) includes making the hysteresis correction differently to the steady-state region and the transitional region (A1, A2) in accordance with the moving direction information.

This aspect allows, by making a hysteresis correction to the transitional region (A1, A2) differently from the steady-state region, the positional information to be stabilized in the region immediately following a point where the magnetic sensor (2) makes a turnaround while making the reciprocating movement relative to the magnetic scale (3).

In a distance measuring method for use in a magnetic sensor system (1) according to a seventh aspect, the correction step (S3, S5) includes transforming the second output signal to allow the second output signal to have an error of the same magnitude as in the steady-state region (in S3) and making an error correction, applied to the steady-state region, to the second output signal that has been transformed (in S5).

According to this aspect, the error correction applied to the steady-state region is made as a hysteresis correction to the transitional region, thus allowing the correction calculation to be simplified.

Note that the constituent elements according to the second to fourth aspects are not essential constituent elements for the magnetic sensor system (1) but may be omitted as appropriate.

Note that the features according to the sixth and seventh aspects are not essential features for the distance measuring method for use in the magnetic sensor system (1) but may be omitted as appropriate.

### REFERENCE SIGNS LIST

1 Magnetic Sensor System
2 Magnetic Sensor
3 Magnetic Scale
4 Linear Stage
5 Control System
6 Controller
7 A/D Converter
8 Moving Distance Transformer
9 Hysteresis Corrector
A1 Transitional Region
A2 Transitional Region
S3, S5 Transformation Step (Correction Step)

1. A magnetic sensor system comprising:
a magnetic sensor;
a magnetic scale disposed alongside of the magnetic sensor in a first direction and configured to move relative to the magnetic sensor in a second direction intersecting with the first direction;
a transformer configured to receive an output signal of the magnetic sensor and transform the output signal into moving distance information; and
a controller configured to receive the moving distance information from the transformer and give a movement instruction to either the magnetic sensor or the magnetic scale,
the transformer including a hysteresis corrector,
the controller being configured to provide the hysteresis corrector with moving direction information about either the magnetic sensor or the magnetic scale, and
the hysteresis corrector being configured to transform the output signal into the moving distance information by making hysteresis correction to the output signal based on the moving direction information.

2. The magnetic sensor system of claim 1, wherein
the output signal includes: a first output signal as an output signal for a steady-state region; and a second output signal as an output signal for a transitional region immediately following a point where either the magnetic sensor or the magnetic scale changes its moving direction, and
the hysteresis corrector is configured to make the hysteresis correction differently to the steady-state region and the transitional region in accordance with the moving direction information.

3. The magnetic sensor system of claim 2, wherein
the hysteresis corrector is configured to transform the second output signal to allow the second output signal to have an error of the same magnitude as in the steady-state region and make an error correction, applied to the steady-state region, to the second output signal that has been transformed.

4. The magnetic sensor system of claim 3, wherein
the hysteresis corrector is configured to:
calculate a correction value P1 applied to a situation where the magnetic sensor moves in a first moving direction in the steady-state region by P1=FP1+c1/2, where FP1 is a measured value and c1 is a total error in a situation where the magnetic sensor moves in the first moving direction in the steady-state region and in a situation where the magnetic sensor moves in a second moving direction opposite from the first moving direction;
calculate a correction value P2 applied to a situation where the magnetic sensor moves in the second moving direction in the steady-state region by P2=RP1−c1/2, where RP1 is a measured value;
calculate a correction value P3 applied to the transitional region immediately following a point where the magnetic sensor changes the moving direction from the first moving direction into the second moving direction by P3=R0−(R0−RP2)×a1/b1+c1/2, where RP2 is a measured value, R1 is a turnaround measured value when the magnetic sensor changes the moving direction from the first moving direction into the second moving direction, a1 is a measured value width of the steady-state region with respect to the transitional region in its entirety, and b1 is a measured value width of the transitional region in its entirety; and
calculate a correction value P4 applied to the transitional region immediately following a point where the magnetic sensor changes the moving direction from the second moving direction into the first moving direction by P4=R1+(FP2−R1)×a2/b2−c1/2, where FP2 is a measured value, R1 is a turnaround measured value when the magnetic sensor changes the moving direction from the second moving direction into the first moving direction, a2 is a measured value width of the steady-state region with respect to the transitional region in its entirety, and b2 is a measured value width of the transitional region in its entirety.

5. A distance measuring method for use in a magnetic sensor system, the magnetic sensor system including: a magnetic sensor; and a magnetic scale disposed alongside of the magnetic sensor in a first direction and configured to move relative to the magnetic sensor in a second direction intersecting with the first direction, the distance measuring method comprising
a transformation step including transforming an output signal of the magnetic sensor into moving distance information about either the magnetic sensor or the magnetic scale,
the transformation step including a correction step including transforming the output signal into the moving distance information by making hysteresis correction to the output signal based on the moving direction information about either the magnetic sensor or the magnetic scale.
